(19) United States
(12) Patent Application Publication
(10) Pub. No.: US 2025/0023932 A1
(43) Pub. Date: Jan. 16, 2025

(54) Systems And Methods For Improving Online Meetings And Webinars

(71) Applicant: Skillfull Inc., Danville, CA (US)

(72) Inventor: Charles Huson, Burlingame, CA (US)

(21) Appl. No.: 18/220,209

(22) Filed: Jul. 10, 2023

(51) Int. Cl. H04L 65/403; G09B 7/00

(52) U.S. Cl. CPC H04L 65/403; G09B 7/00; G06Q 20/16

(57) ABSTRACT

Techniques are disclosed for systems and methods of an online meeting system/platform operating in the cloud. Hosts on respective host computing devices and participants on respective participant devices are onboarded to the platform. After authentication, a host can schedule an online meeting and invite participants to it. After authentication, participants can join the meeting. Meeting content shared by a host is “active” or “hotloaded” and comprises server content as well as client content that is derived from the server content. Client content is available to participants on their participant devices and which they can interact with independently of the server content, and without causing the meeting webpage to reload. Still, the client and server contents remain synchronized. The platform can track an engagement level of the participants with the client content. The technology finds a number of use-cases in online education, auctioning, legal and business domains.

### FIELD OF THE INVENTION

This invention relates generally to online meetings and webinars, and more specifically to the systems and methods for sharing active or hotloaded content between a host and the participants of an online meeting.

### BACKGROUND ART

Online meetings have become a common way for people to meet as a group, but without being at the same physical location. A webinar is a type of an online meeting that mimics a seminar and or presentation conducted by a host or a panel of speakers to an audience. It is designed for a one-to-many communication, where the focus is on delivering information or knowledge to a large number of participants. Webinars often include features to share content with the audience such as slide presentations, live video streaming, chat boxes for participant interaction, and Q&A sessions.

When it comes to online meetings including video conferences, there is plenty of prior art found in the literature. U.S. Pat. No. 11,412,181 B1 to Han et al. teaches a system for sharing content across videoconferencing sub-meetings. The system includes a processor and at least one memory device. The memory device includes instructions that are executable by the processor to cause the processor to establish a videoconferencing session including a main meeting and a first sub-meeting, receive, from a presenter, a content to be displayed in the main meeting, and cause the content to be displayed in the main meeting. The memory device further includes instructions that are executable by the processor to cause the processor to receive, from a first participant in the videoconferencing session, an indication that the content is to be displayed in the first sub-meeting, and cause the content to be displayed in the first sub-meeting simultaneously with the content in the main meeting.

U.S. Patent Publication No. 2012/0128146 A1 to Boss et al. describes techniques for managing subconference calls within a primary conference call. Their approach includes establishing a primary conference call including a plurality of participants, establishing a subconference call including a subset of the plurality of participants, and providing respective output signals to each of the plurality of participants. Members of the primary conference call are provided with audio only of the primary conference call, and members of the subconference call are provided with audio of the subconference call. The approach also includes providing a visual display that shows respective groupings of members of the subconference call and members of the primary conference call.

U.S. Patent Publication No. US 2021/0058264 A1 to Fahrendorff et al. discloses systems and methods for advising meeting participants. Their method of advising meeting participants includes establishing a desired engagement level for a participant of a meeting. The method further includes evaluating a contribution to the meeting of the participant based on the desired engagement level and including at least one of detecting a communication duration of the participant or determining a quantity of content shared. The example method also includes generating a graphical representation of the contribution to the meeting. Additionally, the example method includes providing the graphical representation of the contribution to the meeting, including transmitting a signal to at least one of the participants or a meeting host. The signal communicates the graphical representation to a device of the participant or the meeting host.

U.S. Patent Publication No. US 2016/0261655 A1 to Aggarwal et al. teaches various embodiments for correlating the measured engagement of attendees to an online conference with the content of the online conference. In one implementation, a timeline is displayed in a user interface for at least a portion of the online conference. The timeline correlates the engagement of the attendees with the content of the online conference based on compiling values measured for engagement parameters of the respective attendees at defined time intervals during the online conference. Input is received identifying a point or interval of the timeline of the online conference. In response to receiving the input, content of the online conference associated with the point or interval is identified and displayed. Alternatively or in addition to displaying content, multiple, different ones of the engagement parameters for the point or interval are identified and have the respective values displayed.

U.S. Patent Publication No. 2022/0334790 A1 to Lawrence teaches methods, apparatus, systems, and articles of manufacture for dynamically determining interaction display regions for screen sharing. Example apparatus disclosed are to generate a screen share frame corresponding to content rendered on the display and intended for the screen share event; identify application-related contextual data corresponding to the screen share event; determine an interactive context based on at least one of (a) the application-related contextual data and (b) sensor data from at least one sensor, the interactive context including identification of an interaction region of the screen share frame; generate interaction metadata that includes the interactive context; and transmit a transport stream that includes the interaction metadata and the screen share frame.

U.S. Patent Publication No. US 2016/0034111 A1 to Sahai et al. discloses a computer implemented method and apparatus for generating a contextual timeline of an online interaction such as a web conference. The method and apparatus acquire context, from the perspective of participants in the online interaction, along a timeline. Provided for display to a user is a graphical representation of variations, over at least a portion of the timeline in participant engagement, attentiveness, attendance and/or some other measure of participant interactivity. Also provided for display to the user are one or more images aligned with one or more corresponding points in time along the timeline.

The images provided for display in alignment with the timeline are representative of content presented to the at least one participant at one or more points in time. According to some embodiments, the points in time are user selectable, and the one or more images are provided for display in alignment with the timeline in response to user selections.

ON24® has a product that purportedly measures engagement and viewer interest in a webinar. They argue that one of the main reasons that webinars successfully influence prospects in the buying cycle is their ability to capture the attention of viewers for significant periods of time. According to them viewers, on average, spend 56 minutes in an interactive webcast. They also argue that by combining webinar duration with the ability to assess each viewer's engagement and interest level in the webinar content, provides an indicator of lead quality.

Their product purportedly evaluates viewer engagement on a 10-point scale. The score is a single number used to measure attendees' participation, interactivity, and use of webcast features. Their algorithm weighs the points based on their impact on viewer interest. The factors are: webcast duration and the number of questions answered, widgets opened, polls submitted, surveys completed, and resources viewed.

Despite the plethora of prior art, there are no techniques currently available that would allow sharing of active or hotloaded content between the host(s) and participant(s) of an online meeting. The prior art is also silent about providing a seamless experience to meeting participants whereby they can freely interact with the meeting content without causing the meeting webpage to reload, or without breaking the underlying network connection. The prior art is also silent about providing an effective way to track the engagement level of participants in an online meeting or webinar.

### OBJECTS OF THE INVENTION

In view of the shortcomings of the prior art, it is an object of the present invention to provide systems and methods for online meetings that have the ability to share active or hotloaded content.

It is another object of the invention to provide techniques for allowing meeting participants to interact freely with client content independently of the server content.

It is also an object of the invention to allow for the above interactions throughout the online meeting, without breaking the network connection or without causing the meeting webpage to reload.

It is also an object of the invention to have the meeting webpage include an event container and a content container.

It is further an object of the invention for the content container to present content to the participant that is active or hotloaded.

It is also an object of the invention to provide an effective way for tracking an engagement level of the participant with the online meeting content.

Still other objects and advantages of the invention will become apparent upon reading the detailed description in conjunction with the drawing figures.

### SUMMARY OF THE INVENTION

The objects and advantages of the invention are secured by systems and methods of an online meeting platform. The online meeting platform or computer system operates in the cloud and allows a host user or simply a host to host an online meeting on the platform that participant users or participants join in. In the context of the present technology, an online meeting comprises a webinar or a one-to-many communication or collaboration environment between a host (or a panel of hosts) to one or more participants.

All users are first authenticated on the platform using authentication techniques known in the art. Both the host and participants operate on their host and participant computing devices respectively. The host first schedules an online meeting and invites participants/members to join in. The meeting is initiated when instant online meeting platform generates one or more webpages for the meeting and publishes the webpage(s) on the internet.

At this point, the invite guests/participants/members can join the meeting on the internet by accessing the above webpage of the meeting in a web browser. In turn, the web browser initiates a network connection over the internet or cloud to the web server of the instant online platform. The webserver is responsible for publishing the webpages of the online meetings that are hosted in the platform.

The webpage of an instant online meeting thus accessed by a web browser of a participant, contains an event container and a content container. The event container is preferably meant to play a video (and audio) stream of the meeting and as chosen by the host. Such event content displayed or played in the event container may exemplarily be a video of the meeting host taken by a webcam.

The content container of the webpage is meant to present meeting content to the participants that is known as client content. Client content is derived from the server content uploaded by the host. Client content exists locally on participant computing devices and allows the respective participant to interact with it without ever having to redraw the content container and/or having to reload the webpage. Thus, preferably, the network connection or session of the meeting stays unbroken or intact or uninterrupted throughout the meeting—unlike meeting platforms of the prior art.

The server and client content, collectively referred to as the instant meeting content, is active or “hotloaded”. What this means is that, unlike the prior art, client content exists locally on a participant device/machine and allows the participant to update and change it as needed. Additionally, the client content is also synchronized with its server counterpart. What this means is that any actions taken by the server on the server content are automatically also propagated to and reflected in the client content on the participant devices.

Instant client content can be any type of digital information or content including but not limited to a computer program that executes locally on the participant or client computer system. It may be a file that is viewed or updated on the client system/device. It may also be a link to an external content source. The computer program above contained in the client content and presented in the content container of a meeting webpage, may preferably be a web browser. The browser itself may be used by the corresponding participant to access any resource on the internet.

The client content file mentioned above may be virtually any type of program or data file based on the instant principles. Depending on the variation, the file may be one of a document, including a Microsoft Office™ document, a picture file, a multimedia file, a portable document format (PDF) file, a software code file, an intellectual property file, a text file, a binary file, or any other file. The link in client content mentioned above may point to any resource on the internet including but limited to a video, including a YouTube® video, an audio, a document, including a DocuSign® document, a static content, a picture, or any other internet resource.

In a highly useful set of variations, instant online meeting platform also tracks an engagement level of each participant with their respective client content. The engagement level may be tracked by analyzing how much time the participant has spent viewing or interacting with the meeting content, how many quiz or surveys that they have answered, what are their scores/grades on such quizzes, or other pertinent metrics.

The above variation is very useful when the online meeting platform is used as a learning management system or LMS. In such an LMS embodiment, the host is a teacher or instructor, the participants are students or test takers and the meeting content is a course, a book, a manual, a video, an audio or any other educational content. The system preferably grades the students based on the number of questions that they have answered correctly. In a preferred variation, the system can issue a certificate of completion to those students who have a high enough engagement level with the course and have scored above a given threshold on tests/quizzes.

In a another highly useful set of embodiments, the present online meeting platform is used in a business or legal setting. In these embodiments, the host may be an attorney or a business person, a partner, or the like, and the client participants may be customers, prospects, legal clients, or the like. The meeting content in such embodiments is preferably a business document, a fillable or signable form, such as a legal contract or an agreement.

By analyzing a video stream of the participant in conjunction with the engagement level tracking capability of the instant platform, the host has a visual as well systemic confirmation that the participant has consumed the content. At the end of such a session or meeting, the participants/clients/business partners may sign the signable or fillable form of the agreement/contract and which then becomes a signed legal/business document. To summarize, the engagement level tracking capability may be combined with a review of the visual footage of the participants/clients so that the host can ensure that the form/agreement/contract was properly reviewed before signing.

In yet another variation, instant online meeting platform is used as an auctioning platform. In such a scenario, host is the auctioneer, participants are the bidders and the meeting content is the description of the items being auctioned. In other preferred variations, a payment module is also built/integrated into the instant online meeting platform. Using the payment module, platform users can pay one another depending on the application. For example, when used as an LMS, students can pay the teachers for the course via the payment module, bidders can tip the online auctioneer, clients can pay their service providers and so on.

The apparatus of the present technology comprise an online meeting platform executing program instructions by at least one microprocessor, said program instructions stored in a non-transitory storage medium operably connected to said at least one microprocessor, said at least one microprocessor configured to: upload by host, server content of an online meeting to said online meetings platform, and publish one or more webpages of said online meeting over a computer network; a participant computer system executing program instructions by at least one microprocessor, said program instructions stored in a non-transitory storage medium operably connected to said at least one microprocessor, said at least one microprocessor configured to: execute a web browser that accesses a webpage from amongst said one or more webpages via a network connection over said computer network and renders said webpage on a computer display for a participant of said online meeting; wherein said webpage comprises an event container and a content container, and wherein said event container comprises one or both of an audio stream and a video stream of said online meeting, and wherein said content container comprises a client content of said online meeting, said client content based on said server content and existing locally on said participant computer system, and wherein said participant performs an interaction with said client content independently of said server content and without causing said webpage to reload.

The methods of the present technology include executing computer-readable instructions by at least one microprocessor, said instructions stored in a non-transitory storage medium coupled to said at least one microprocessor, and said method comprising the steps of: uploading by a host operating a host computer system, server content of an online to an online meetings platform, and publishing one or more webpages of said online meeting over a computer network; executing a web browser on a participant computer system for accessing a webpage from amongst said one or more webpages via a network connection over said computer network and rendering said webpage on a computer display for a participant of said online meeting; including an event container and a content container in said webpage, and including one or both of an audio stream and a video stream of said online meeting in said event container; including client content of said online meeting in said client container, deriving said client content from said server content, and providing said client content to exist locally on said participant computer system; and performing by said participant an interaction with said client content, without reloading said webpage.

Clearly, the system and methods of the invention find many advantageous embodiments. The details of the invention, including its preferred embodiments, are presented in the below detailed description with reference to the appended drawing figures.

### BRIEF DESCRIPTION OF THE DRAWING FIGURES

FIG. 1 is the conceptual diagram of an embodiment of the instant online meeting platform showing various meeting hosts and participants.

FIG. 2 shows the layout of a webpage of an instant online meeting, comprising event and content containers.

FIG. 3 shows an embodiment that is particularly adapted for an online educational environment or an online learning system.

FIG. 4 shows another variation that is suitable for education, auction, legal, business or other domains.

FIG. 5 shows a high-level architectural diagram of an exemplary implementation of the present technology using Amazon Web Services (AWS).

FIG. 6 shows a class diagram of an exemplary implementation utilizing the C# programming language of Microsoft's .NET framework.

FIG. 7 presents a screenshot of an instant online meeting webpage from an exemplary implementation of the present technology with both the event and content containers shown.

FIG. 8 presents a screenshot of an instant online meeting webpage from an exemplary implementation of the present technology where the content container is hidden.

FIG. 9 presents a screenshot of an instant online meeting webpage from an exemplary implementation of the present technology showing an actionable content of a video that is required by the host to be watched.

### DETAILED DESCRIPTION

The figures and the following description relate to preferred embodiments of the present invention by way of illustration only. It should be noted that from the following discussion, alternative embodiments of the structures and methods disclosed herein will be readily recognized as viable alternatives that may be employed without departing from the principles of the claimed invention.

Reference will now be made in detail to several embodiments of the present invention(s), examples of which are illustrated in the accompanying figures. It is noted that wherever practicable, similar or like reference numbers may be used in the figures and may indicate similar or like functionality. The figures depict embodiments of the present invention for purposes of illustration only. One skilled in the art will readily recognize from the following description that alternative embodiments of the structures and methods illustrated herein may be employed without departing from the principles of the invention described herein.

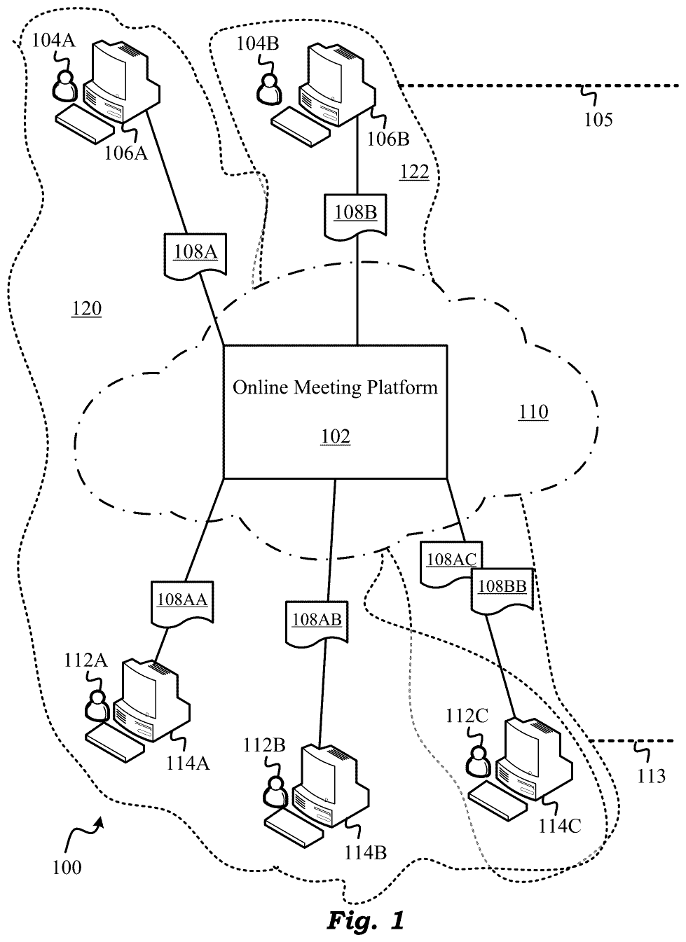

The present invention will be best understood by first reviewing an embodiment 100 comprising an online meeting platform or an online meeting computer system 102 according to the present teachings as illustrated in FIG. 1. As shown in FIG. 1, there are one or more online meeting hosts or simply hosts 104A, 104B, . . . at their respective host computer systems 106A, 106B, . . . in communication with platform 102 via a computer network 110. In the context of the present disclosure, an online meeting comprises a one-to-many communication or collaboration environment between a host (or a panel of hosts) to one or more participants. This is different from a standard video conference that has a many-to-many collaboration environment.

Computer network 110 shown by dotted-and-dashed line may be any computer network including the internet. As such, we may refer to online meeting platform or server 102 to be operating in/over the “cloud” or specifically in/over cloud 110. Further, as shown by dotted line 105, any number of such online meeting host users or hosts 104 operating on their respective host computer systems 106 and in communication with online meeting platform 102 over cloud 110 may be present. Furthermore, while we may refer to a host 104A in the singular, it is understood that there may be a group or panel of such hosts on host computing device or devices 106A hosting or conducting an online meeting of the present technology.

FIG. 1 also shows one or more online meeting participant users or online meeting participants or simply participants 112A, 112B, 112C . . . at their respective participant or client computer systems 114A, 114B, 114C . . . Participants or guests or members or audience 112 are also in communication with online meeting platform 102 in/over cloud 110. Analogously to meeting hosts 104, and as shown by dotted line 113, any number of such online meeting participants 112 operating on their respective participant/client computer systems 114 may be present.

Host computer systems 106 and participant computer systems 114 comprise any type of computing devices. These include but are not limited to desktops, laptops, smartphones, tablets, smartwatches, mobile computing devices, or any other computing devices. They should have enough computing and network capability to run a web browser and make a connection to online meeting platform 102 over internet 110 and consequently interact with instant meeting content as taught herein.

According to the chief aspects, participants 112 via their respective participant computer systems 114 participate or join in one or more online meetings. These meetings are hosted on online meeting platform 102, and the one or more online meetings are hosted or conducted by one or more hosts 104 via their respective host computer systems 106.

Typically, each of hosts 104, e.g. host 104A would host/conduct one online meeting at a time. Host 104A would first schedule the online meeting and invite one or more guests or participants 112 to the meeting. The participants would then join the meeting hosted on online meetings platform 102 after authentication. Authentication of various users on platform/server 102 including hosts and participants is performed using one or more of the various authentication techniques known in the art.

Typically, at the onset of the online meeting, or even before or thereafter, hosts 104 would upload respective meeting content 108 from their respective host computer systems 106 to platform 102 which will be used to conduct their respective meetings. Two such instant online meetings 120 and 122 are shown by dotted-line shapes in FIG. 1. Content 108 uploaded by hosts 104 for their respective online meetings to instant online meeting platform 102 is referred to as server content according to the present disclosure. Exemplary server content 108A uploaded by host 104A for online meeting 120 is shown. Now, once a participant, e.g. participant 112A joins online meeting 120, he/she/they can access client content 108AA that is required for the meeting.

Client content 108AA is derived from or based on server content 108A that was uploaded to meeting platform 102 by host 104A. Unlike the systems of the prior art, client content 108 for participants 112 is available locally on their respective participant computer systems 114. This is one of the key contributions of the present design and is fundamentally different from traditional screen-sharing technologies.

Let us assume that host 104A uploads server or host content 108A, which is exemplarily a presentation, via host computer system 106A to online platform 102 for an online meeting 120 that the host intends to conduct. Now, instant online meeting platform 102 prepares and publishes one or more webpages for online meeting 120 on network/internet/cloud 110. This webpage or webpages of online meeting 120 are accessed or downloaded by participants of meeting 120 on their web browsers running on their respective participant computer systems 114. The participants access the webpage(s) of the meeting by accessing the URLs of the webpages using the familiar http/https requests of their web browsers.

Explained even further, participants 112A, 112B and 112C are using their respective computer systems 114A, 114B and 114C to join online meeting 120 hosting on instant platform 102. Participants 112A-C use web browsers running on their respective participant computer systems 114A-C to accesses the webpage of the online meeting conducted by host 104A via host computer system 106A over internet 110.

Based on the instant design, presentation 108A is now also locally available to participants 112A, 112B and 112C on their respective computer systems 114A, 114B and 114C as client content or local presentation 108AA, 108AB and 108AC respectively. While the meeting is being conducted, participant 112A can edit and save a local version of presentation 108AA to their participant or client system 114A, participant 112B can also edit and save a local version/copy of the presentation 108 to their participant system 114B and so on. Based on the present technology, the above-mentioned meeting presentation 108A or any other content uploaded by hosts 104 is served as “active” or “hotloaded” content to meeting participants 112. This is one of the key innovations of the present design over the typical screen-sharing or other capabilities of the prior art.

As shown in FIG. 1, participants 112A-C are participating in meeting 120, while participant 112B is also participating in or is a member of meeting 122 hosted by host 104B who has uploaded server content 108B. Client content 108BB is available to participant 112B locally on client computing system 114C. The active client content or simply client content 108AA, 108AB, 108AC is derived from or based on or contained in or a copy of server content 108A. Similarly, the active client content or simply client content 108BB is derived from or based on or contained in or a copy of server content 108B.

By virtue of the active nature of the instant meeting content i.e. server content 108A and client content 108AA, 108AB and 108AC, any action performed by the host on the server content is immediately reflected on the client content. This is accomplished by having a continuous connection between the participant computer systems 114 and meeting platform 102. As such, “immediately reflected” above is a function of how fast the speed or the available bandwidth of network/cloud/internet 110 at the time of the interaction would allow. We may also refer to the instant meeting content with its server and client counterparts to be thus synchronized based on the instant principles.

Exemplarily, if the server content 108A is a pdf file and the host has scrolled the pdf file to page 22, then the client versions/content 108AA, 108AB and 108AC of the pdf file will also scroll the pdf file to page 22. At the same time, participants 112 can also performed any local interactions to the client content 108AA-C. However, those interactions stay local to respective participant computer systems 114A-C and are not propagated to other participants or the host. Instead of the pdf file, the content file may be a Microsoft PowerPoint file, a Microsoft Word document, a source code file, an executable file including a JavaScript® program/application, a video file, an audio file or any other file or content.

Based on the present technology, the server and client content can literally be any type of digital information or media that is created, stored, and accessed by users. This includes various forms of data, including text, images, videos, audio files, computer programs, interactive elements, or any other content. In the example above, content 108 was a presentation or a slide-deck, such as a Microsoft PowerPoint® file. However, it can be any Microsoft Office® document, a picture file, a multimedia file, a portable document format (PDF) file, a software code file, an intellectual property file, a text file, a binary file among others.

Instant client content may be static content that a participant just views or it may be dynamic content that changes over time. Instead of or in addition, it may be interactive or actionable content that the participant interacts with or is required to interact with by the host or performs changes and updates to. While in many cases, the client content may just be a local replica of server content, that is not necessarily the case. What this means is that there may be additional data or code in server content that is used by platform 102 for administrative/housekeeping or other purposes, but not shared with the participants. That is why we refer to the client content to be based on or derived from the server content.

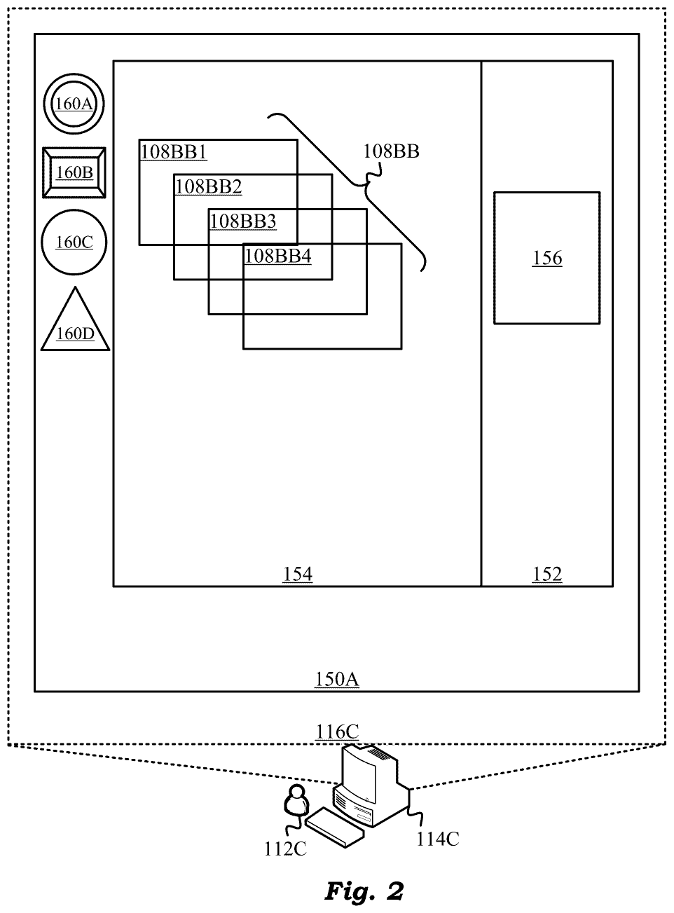

Let us now further review the details of the webpages served or published by online meeting platform or server 102. These webpages are subsequently accessed or downloaded by meeting participants 112 on their participant computer systems 114 per above. Let us take advantage of FIG. 2 to assist in this explanation. FIG. 2 shows a webpage 150 of an online meeting, e.g. meeting 122, conducted on platform 102 of FIG. 1 by a host 104B. Webpage 150 is accessed and downloaded by a participant, e.g. 112C, using a web browser running on participant computer system 114C as shown. The web browser displays webpage 150 on a display of participant computer system 114C from FIG. 1. The display of computer system 114C on which web page 150 is displayed is shown by the dotted-lined box 116C belonging to system 114C of FIG. 1.

According to the present design, web page 150 contains an event container 152 and a content container 154. Content container 154 is also sometimes referred to as canvas 154. Display 116C may show more than one such webpages, each belonging to an online meeting on platform 102 that participant 112C is attending. However, for clarity, only one such webpage 150 of an online meeting, e.g. meeting 122 of FIG. 1 which participant 112C has joined or is a member of, is discussed presently to facilitate explanation. In related variations, there may be multiple content containers on a single canvas. However, we will pay special emphasis to embodiments that have a single content container on the canvas and hence use the terms content container and canvas interchangeably.

Each of event and content containers 152 and 154 respectively may be implemented as graphical user interface (GUI) windows within webpage 150. Event container 152 contains a video or an audio stream 156 of the meeting. Such a video or audio stream typically consists of the live video and audio, or video only or audio only streams of the meeting host. Participant 112C of meeting 122 can thus see and/or hear host 104B in event container or window 152 via stream 156 of meeting webpage 150. However, event container 154 can be used to stream or “play” any content 156 live or pre-recorded as desired by host 104B.

Webpage 150 also has a content container 154 as shown. A content container is where the active or interactive client content of the present technology is presented to meeting participants 112 see and where they interact with it. Client content 108BB of meeting 122 from FIG. 1 is indicated by the bracket shown in FIG. 2. Client content 108BB is derived from server content 108B that is uploaded by host 104B to server 102 for the meeting. There can be any number and type of such content files or programs or data, including data files, videos, audios, pictures, programs or any other type of digital information. contained in client content 108BB. FIG. 2 shows 4 such types of content 108BB1, 108BB2, 108BB3 and 108BB4.

As noted, the present technology allows for a large variety of such active client meeting content 108BB, that our meeting participant 112C can locally and freely interact with independently of server content 108B. What this signifies in practical terms is that client/participant 112C can perform any interaction with client content 108BB without causing webpage 150 of meeting 122 to reload or for content container or canvas 154 to be redrawn. This is another contribution of the present design.

Any of such client content files 108BB can be edited or executed locally by participant 112C on participant computer system 114C. These content files are executed within content container 154 of webpage 150. For example, in one sub-window of content container 154 a video file may be playing locally on computer system 114C as client content 108BB1. In another sub-window a Microsoft Office document may be open and viewed/edited locally on computer system 114C as client content 108BB2. In yet another sub-window of webpage 150 a computer program may be executing locally on computer system 114C as client content 108BB3.

Exemplarily, above computer program 108BB3 is a web browser that may be used to access a Uniform Resource Locator (URL). Alternatively, it can be any executable running on computer system 114C. In yet another sub-window a link is being accessed, exemplarily by a web browser, to fetch external content as client content 108BB4 onto computer system 114C, and so on. Exemplarily, such an external link is used to access and play a Youtube video on system 114C, make a payment to a host, show and interact with a fillable form, display an image on system 114C, or view/update any other external content.

All such content 108BB1-N is available to participant 112C in content container 154 as various icons in a virtual content list of host 104B on webpage 150. When user/participant 112C clicks on one such icon, it initiates a connection to the server counterpart of that content on platform 102. Using the connection, a local version of the content 108BB1-N is fetched that is viewed/executed locally on participant computer system 114C. Simultaneously, the audio/video stream or any event content of the meeting, e.g. audio/video of host 104B, is executed/played in event container 152. The experience for participant 112C is seamless because they can view and interact with their content in content container 154 without leaving their browser window or going to a different screen, and while at the same time also watching the meeting in event container 152.

Among many different use cases, the present technology is particularly suited to conduct webinars. In a webinar, the webinar host is shown in event container 152 while the webinar participants simultaneously view or interact with client content in canvas 154. They can do so without ever having to leave webpage 150, without opening new a browser window/tab, and without going to a new screen as in the prior art systems.

FIG. 2 also shows other useful screen widgets, i.e. radio buttons, buttons, sliders, or the like as icons 160A, 160B, 160C and 160D. Icons/widgets 160 perform various tasks on online meeting platform 102 for the user or participant 112C. For example, widget 160A is a radio button that allows user to turn their camera on or off. Widget 160B allows a host user to upload a server content file. In the present case, if user 116C is a meeting participant only, upload button 160B will be greyed out. Otherwise, this button is enabled. Note, it is possible for a user of instant platform 102 to be simultaneously a host of one meeting and a participant in another meeting. Other widgets 160C, 160D, . . . also implement useful tasks for the user e.g. muting/unmuting microphone, enter/leave the meeting, open a chat dialog box, ask question of the host, make a payment to the host or another participant, or any other desired function.

It is also possible that for a given online meeting hosted on platform 102, there is no content shared by the host. In such a scenario, webpage 150 would only show event container 154 with an event content or event stream 156 played or executed. Content container 154 in such a scenario would be hidden or blank or not displayed. It is also possible to host a meeting on instant meeting platform 102 without a human host. In such a scenario, a computer program or script is used to host the meeting, play any event content/stream 156 in event container 152. Further, the computer program or script may also upload server content as/if needed to platform 102 based on which client content is derived per above teachings, and which is accessed/downloaded by participants 112 of the meeting.

As stated above, by virtue of the active or hotloaded nature of meeting content afforded by the present design, meeting participants can perform any interaction with the client content without causing the webpage(s) of the meeting to reload. Moreover, content container 154 of FIG. 2 also never needs to be redrawn throughout the meeting. What this means is that the network connection in cloud or network 110 of FIG. 1 remains unbroken, intact or stays connected regardless of the interactions of the participants with the client content.

In other words, the network connection or session of the meeting that a participant uses for the meeting stays unbroken throughout the meeting. This is another key innovation of the present technology. This capability provides for a much more streamlined and seamless user experience than the technologies of the prior art. Furthermore, as already noted above, any action performed by the host on the server content is also immediately reflected in the client content.

Referring to FIG. 2, when webpage 150 is first loaded, event container 152 and content container 154 are equally sized on webpage 150. However, participants 112 are free to resize their event or content container. Once again, this interaction does not cause webpage 150 to reload or containers 152, 154 to be redrawn as in the systems of the prior art.

As further consequence of the present design, specifically the active/hotloaded nature of the instant meeting content of the present teachings, a number of benefits are accrued for a practitioner. One such benefit is that the online meeting platform 102 can track all interactions of participants 112 with their respective client content 108. The present technology is therefore said to be able to track the engagement levels of meeting participants 112. This is a very important capability for a number of reasons.

In one application, such as a webinar, the host can set a requisite engagement level or threshold which may be a numerical value, for each participant. Platform 102 then numerically scores and grades the interaction engagement level of each participant 112 with their respective client content. If a participant reaches the requisite threshold or engagement level preset by the host, online meeting platform automatically gives a credit to the participant. The credit may also be given monetarily by utilizing a payment module/service of platform 102 that is not explicitly shown in FIG. 1. to avoid clutter. Such a capability is also useful when platform 102 is used as a learning platform.

In fact, as just one of its very useful applications, present online meeting platform 102 is ideally suited to serve as a learning management system (LMS). Such an instant LMS is a web-based platform that facilitates the administration, delivery, and management of educational courses and training programs. Instant platform thus acts as a centralized hub for organizing and delivering learning content, tracking learner progress, and facilitating communication between hosts/instructors and students/learners.

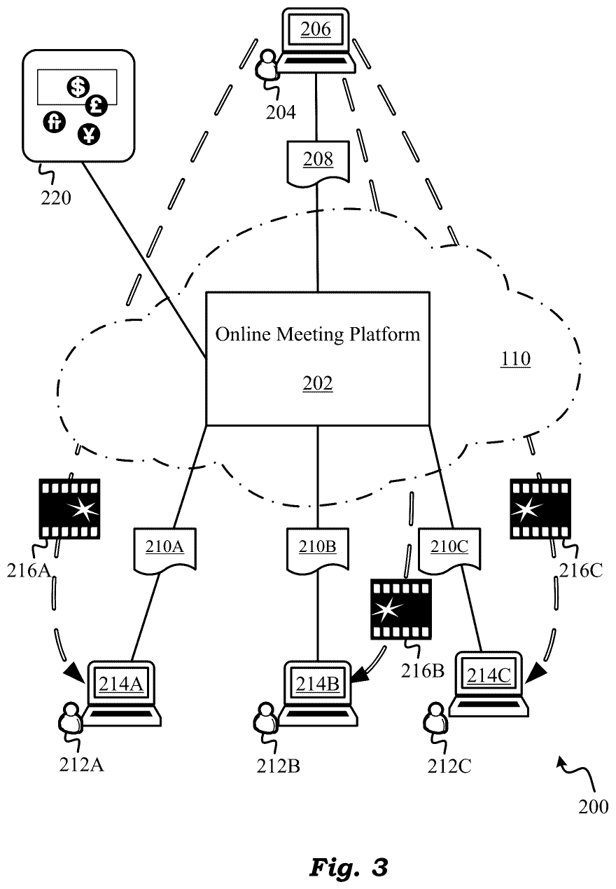

Let us now review such an LMS based on the present principles in greater detail. For this purpose, let us take advantage of FIG. 3. FIG. 3 illustrates in a block diagram form 200, a learning management system or LMS embodied by an instant online meeting platform 202. There is an instructor or teacher 204 operating a host computing device 206, e.g. a desktop, to access LMS 202 over internet 110 from FIG. 1. There are a number of students or learners or test takers 212 on respective computing devices 214 using any combination of smartphones, tablets, laptops, desktops, smartwatches, etc. By utilizing computing devices 214, students 212 interact with teacher 204 via LMS 202 to achieve their educational objectives. Of course, any number of teachers 204 and students 212 maybe onboarded on/to platform 202.

In one embodiment, teacher 204 uploads an online course to platform 202 as server content 208. Platform 202 allows teacher 204 to curate the contents of course 208 as needed for their intended audience or students 212. Per above teachings, course 208 is available as respective interactive client content or course 210A, 210B and 210C to students 212A, 212B and 212C. In one scenario, teacher 204 sends the course files 208, exemplarily as pdfs or ppt files, to students 212 beforehand i.e. prior to the commencement of the online meeting or session.

Alternatively or in addition, when the session begins, teacher 202 can scroll course book 208 to page 243. Because of the synchronized or active nature of instant meeting content per above teachings, the host action will cause client content courses 210 to also automatically scroll to page 243. FIG. 3 also explicitly shows event contents or streams 216A, 216B and 216C for respective participants 212A, 212B and 212C. These streams are viewed/audited in their respective event containers by participants/students 212 per above teachings.

Furthermore, web-based LMS platform 202 is also integrated with a payment module or system 220 as shown. Teacher 204 can thusly charge students 212 for course 208, who can then pay the teacher via the payment module/system. An exemplary payment system or service that may be utilized for this purpose is Stripe®. Any other payment system/service/method 220, electronic or otherwise, may be utilized by platform 202 within the scope of the present principles, using which various users can pay one another.

Per above discussion, meeting or course contents 210A-C are active, allowing respective students to interact with them. This means that teacher 204 can give any requisite quizzes or tests to students 212 online, who can then take the tests and get graded. Unlike the teachings of the prior art, course contents 208/210 are not static and do not need to be downloaded to participant or client computers/machines 214. Nor are they screen-shared i.e. simply exist on host system 206 and viewed remotely by students 212.

Instead, content 208/210 is active/interactive and students 212 can interact with it. They can provide direct feedback to teacher 204 on their progress by using this capability. Such an interaction may take various forms, from a simple multiple-choice quiz to more descriptive answers or showing a method of solving a complex problem. Moreover, LMS 202 also tracks the engagement level of students 212 with course 208. The length of the event stream of the event content in their event container as well as all user interaction with the contents of the content container are tracked and associated with the individual authenticated student/user at the completion of the course. Exemplarily, the event is stream is the familiar webinar video stream, but it can be any other type of event content.

Participant interaction is given a grade based on the engagement level set by the host. If the user achieves this level, credit is automatically given by platform 202. Depending on the embodiment, based on their performance on a quiz and/or engagement level, teacher 204 can grade the students and communicate a certification of completion to those students who have passed the course. In some embodiments, LMS 202 automatically scores the answers of students 212 to the questions in the quiz. For this purpose, platform 202 may utilize artificial intelligence (AI) techniques known in the art.

LMS 202 is suitable for a variety education and learning applications. These include hosting various types of standardized exams or tests in various disciplines, including but not limited to Department of Motor Vehicles (DMV) tests, Real-Estate Examination tests, Nursing Examination tests, among others. In all such applications, teachers 204 and students 212 authenticate themselves on platform 202 first. Then they take one or more courses 208 offered by a teacher 204. Subsequently, they take an examination or test and determine if they have passed or failed. The present technology greatly improves, simplifies and streamlines the user experience of such learning applications than any systems of the prior art.

LMS 202 can also be used by online colleges and universities. By incorporating engagement tracking capabilities discussed above with facial recognition technologies, system 202 can identify and discourage cheating or other unethical practices amongst students. More specifically, one or more of the many facial recognition technologies available in the art can be used to analyze a video stream of the students or test takers. This analysis can be used in conjunction with LMS 202 to ensure that a student on record on platform 202 who is supposed to be taking the test is actually the one taking the test. If not, a suspect event is raised that flags a potential cheating issue to be investigated further. This solves a key problem of cheating for such online institutions.

The following is a partial list of the various features/capabilities of LMS 202 of the present technology shown in FIG. 3:
Allows teachers to curate custom content for their intended audience. By audience here we mean the students or participants on the instant platform of a given online meeting hosted by a host or teacher. These participants are the “customers” of their respective host/teacher.
Enables subscription educational services for students, who can utilize payment module 220 to pay for the subscription on a periodic basis.
Enables live events, including one-on-one sessions as swell group webinars.
Provides Interactive Courses.
Able to provide “at your own pace” courses to students.
Provides many ways for teachers/curators to present their content by uploading files/contents directly to their project on platform 202. Per above teachings, such uploaded content can include links to external content sources, including:
   YouTube videos
   Fillable forms
   Computer programs, including JavaScript
   programs/applications
   Image files
   Documents
   Any other static or dynamic content
Provides custom video processing to ensure that all uploaded videos are viewable on any type of computing hardware platform or device and any operating system.

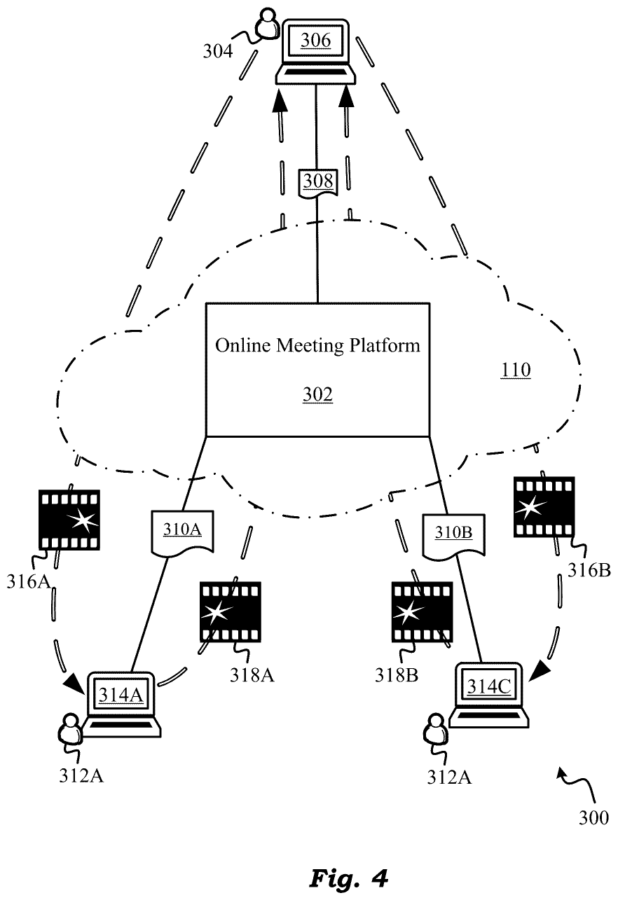

Yet another highly interesting application of the present online meeting platform, e.g. platforms 102/202 of FIG. 1/FIG. 3, is in the business or legal domains. FIG. 4 shows such an embodiment 300 as a variation of the prior embodiments. Not all the elements and reference numerals from the prior embodiments are shown in FIG. 4 to avoid clutter. In a business or legal or a related setting, host 304 operating a host computing device 306 may be an attorney or a company officer or a company representative or the like. The host holds a secure session with prospect(s) or client(s) or business partner(s) or the like 312A and 312B operating respective participant or client computing devices 314A and 314B, on instant online hosting platform 302 of the present teachings.

As in the prior embodiments, the process begins with both the host and the participant(s) authenticating on platform 302 and joining the session. Host 306 then shares a legal or business document, which may be a fillable and/or signable form, as server content 308 with the clients who interact with it as their respective client contents 310A and 310B per above teachings. Clients 312A and 312B are also able to view/audit respective event streams or contents 316A and 316B playing in their respective event containers per above.

The platform can track the engagement level of the participants so that the host can be sure that the participants have reviewed the document. This is further corroborated by video/audio feeds 318A and 318B of participants 312A and 312B respectively, viewed/audited by host 306 as shown. Thus, as/if needed, the host has a visual and/or systemic confirmation that document 308 has been reviewed by participants 312. Then, the participants can “live-sign” the document/form, which is then available as a signed legal or business document for the host. For signing of the document, an appropriate document signing capability implemented within platform 302 may be utilized.

Alternatively, such a capability may be accessed as an external service such as DocuSign. In such a variation, document 302 may be passed to participants 312 by host 306 as an external link to the DocuSign document in their respective content containers of the above discussion. Further, embodiment 300 of FIG. 4 can be used in a variety of different business/legal settings including but not limited to the tedious yet all important signing of Non-Disclosure Agreements (NDAs).

Moreover, the present technology is ideally suited to serve the needs of a variety of other interesting industry applications. Therefore, another useful application of the present technology is in online auctions. To review this application in detail, let us utilize embodiment 200 shown in FIG. 3. In an auctioning application, host 204 is the online auctioneer on their computing device 206. Meeting content 208 and 210 comprise the description of the item being auctioned as shared by host 204 with the bidders. The bidders are participants 212 on their respective computing devices 214.

As the online meeting or auction proceeds, each bidder 212 can make their bid to auctioneer 206 in a chat dialog box available on the webpage of the online meeting and per above teachings. Furthermore, if desired, a bidder, e.g. bidder 212B, can also tip the auctioneer by utilizing payment module 220. The bidder can do this from the same instant webpage of the online meeting without ever having to leave the webpage or breaking their session for payment processing and redrawing the content and/or event containers of the prior teachings. This is a major improvement of the instant design over traditional online auctioning technologies. An exemplary webpage of an instant online meeting was discussed in detail in reference to FIG. 2 above.

Yet another useful application of the present technology is in performing online surveys. A host acting as a surveyor on the instant platform can share the survey as a fillable survey form as instant server content. Participants of the survey can answer the survey as instant client content on their respective participant computer systems or devices. The surveyor can also provide a monetary reward to the participants by utilizing the payment capabilities of the instant platform per above teachings. Another related and useful application is in conducting polls by utilizing the instant platform.

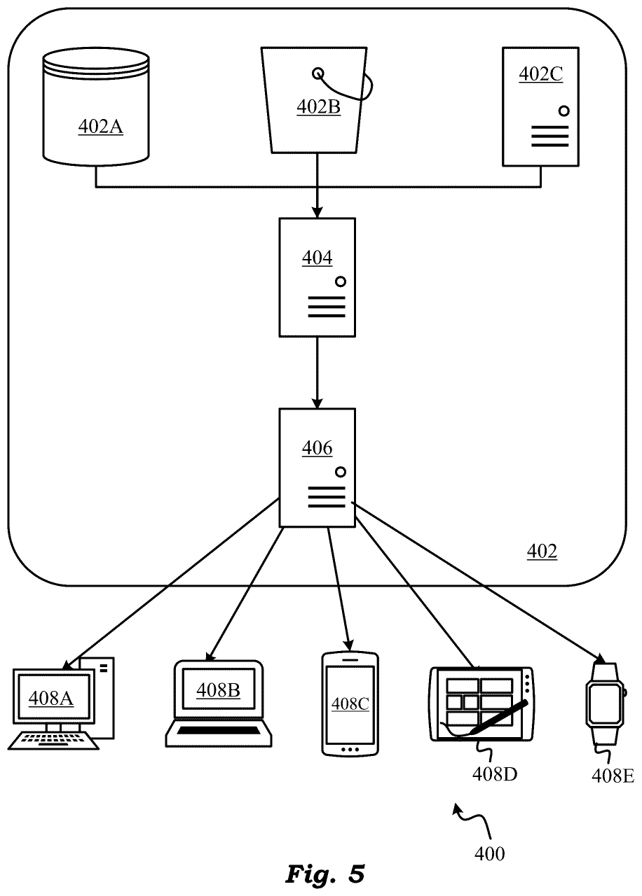

The present design can be implemented using a number of hardware and software computer technologies. In one exemplary implementation, instant online meeting platform is implemented in the cloud using Amazon Amazon Web Services (AWS). The high-level architectural diagram 400 of such an implementation is shown in FIG. 5. More specifically, FIG. 5 shows an infrastructure 402 of the present technology that is implemented in AWS.

Infrastructure 402 uses a database 402A, which is exemplarily a MySQL database. MySQL is an open-source and widely used relational database management system (RDBMS), making the implementation cost-effective and flexible for hosting a variety of workloads of the instant online meeting platform. Database 402A in infrastructure 402 is used for storing administrative/management data including user account profile information, userids and passwords.

An additional storage facility 402B used by infrastructure 402 of implementation 400 is AWS Simple Storage Service (S3). AWS S3 is a cloud-based object storage service provided by AWS. The storage is offered in buckets and provides a secure, durable, and highly scalable storage for various types of data, such as documents, images, videos, backups, and application data. Storage 402B in infrastructure 402 is used to store content utilized in the online meetings conducted on our online meeting platform 102, 202 and 302 of the prior teachings. As noted above, this content includes video files, audio files, pictures, documents, applications/programs or any other content. MySQL database 402A and S3 storage 402B provide the main storage mechanisms in infrastructure 402.

There is a background processing server 402C also running in/as an Amazon/AWS VM. Processing server 402 is tasked with executing the main executable code in one or more processors for realizing the various capabilities of the instant online meeting platform taught herein. Processing server 402C works in close conjunction with webserver 404 further discussed below for publishing the webpages of the hosted online meetings.

Webserver 404 also runs in/as an Amazon/AWS VM as shown. Webserver 404 is directly responsible for publishing the webpages along with their event and content containers and any other web elements for the online meetings hosted on instant platform per above teachings. As will be appreciated by skilled artisans, proxy server 406 acts as an intermediary between client devices 408 and webserver 404 operating on the internet. When a participant/client device requests an internet resource, it sends the request to the proxy server instead of directly to the destination web server.

FIG. 5 shows four exemplary participant devices: a desktop 408A, a laptop 408B, a smartphone 408C, a tablet 408D and a smartwatch 408E. Any type and number of participant or client devices 408 may be present. Thus, client devices 408 access the webpage(s) of an instant online meeting published by webserver 404 in infrastructure 402 via proxy server 406. Webserver 404 working in conjunction with processing server 402C and database/storage 402A/402B deliver the web-based online meetings experience to various participants operating on participant/client devices 408 based on the present teachings.

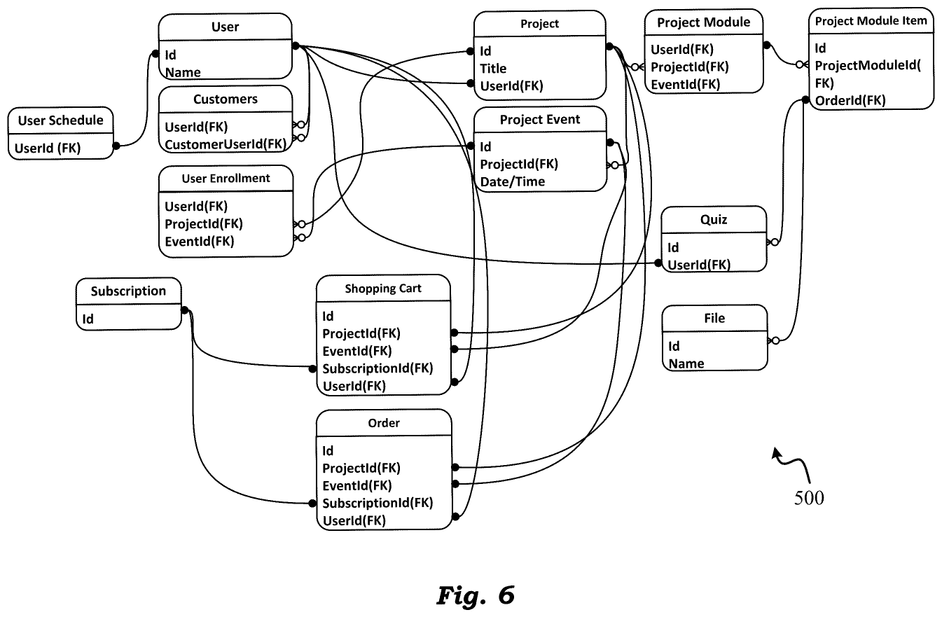

FIG. 6 shows a class diagram from an exemplary implementation. These classes are implemented in C# programming language of Microsoft's .NET Framework/Architecture. Classes User Schedule, User, Customers, User Enrollment, Subscription, Shopping Cart, Order, Project, Project Event, Project Module, Quiz, File, Project Module Item are marked with reference numerals 502, 504, 506, 508, 510, 512, 514, 516, 518, 520, 522, 524 and 526 respectively. Solid circles denote aggregation, while empty or unfilled circles represent associations. Only two such solid circles and two such unfilled/empty circles are marked with reference numerals 530, 532 and 534, 536 respectively to avoid clutter.

An aggregation or composition relationship represents a “has-a” relationship where one class contains or is composed of another class. It indicates a whole-part relationship, where the whole can exist independently of the parts. An association relationship signifies that two classes are associated but not in a composition or aggregation relationship. Furthermore, the three-legged connections denote multiple instances or “is to many” relationship. Only two such connections are marked with reference numerals 538 and 540 to avoid clutter. The three-legged connections denote that there can be many instances of that class in that relationship.

Thus, based on class diagram 500 of the present exemplary implementation, User class 504 has a 1:1 relationship with a User Schedule class 502 in an aggregation relationship. In other words, a User Schedule is contained in a User class. Similarly, a Quiz class 520 is also contained in User class 504. However, there can be many Quizzes 520 in a Project Module Item class 524. To avoid repetition, the rest of the classes and their interrelationships are provided in class diagram 500 and not explicitly described in this explanation.

The following list further summarizes some of the key features of the instant online meeting platform taught herein.
1. Integrating and coalescing/combining various services and content providers, including Stripe. This way, payouts and rewards may be seamlessly performed without requiring their housekeeping inside the instant platform
2. Surveys/Quiz—customized survey/quiz capabilities for users so that they can curate a variety of content. Exemplarily, if any of the courses allow for a certificate of completion, the host/curator can add a survey/quiz to their course to have confidence that the content was consumed.

Further, custom inputs allow the host/curator to have many options for creating a survey/quiz, including but not limited to single selection questions, multiple-choice questions, free-form text, or any other form of input. The GUI controls/widgets for how the content is presented to the participants are also customizable.
3. Customer management
   a. Customizable and built-in E-commerce engine in the instant platform allows hosts to view their own participants/customers of a given online meeting privately. They can thus maintain contact with them and provide invitations to new curated content. By virtue of the instant E-commerce engine of the online meeting platform, hosts are able to:
      i. View/manage order history of various courses or subscriptions purchased by their participants or customers.
      ii. View invoices of monies collected via the payment module.
      iii. View the status of completion of courses so they can issue certificates via the instant platform or manually if they so choose. In conjunction, they can provide assistance proactively to their customers.
4. Platform Subscriptions—This capability allows a user of the platform to gain access to more features as they upgrade their subscription on their platform.

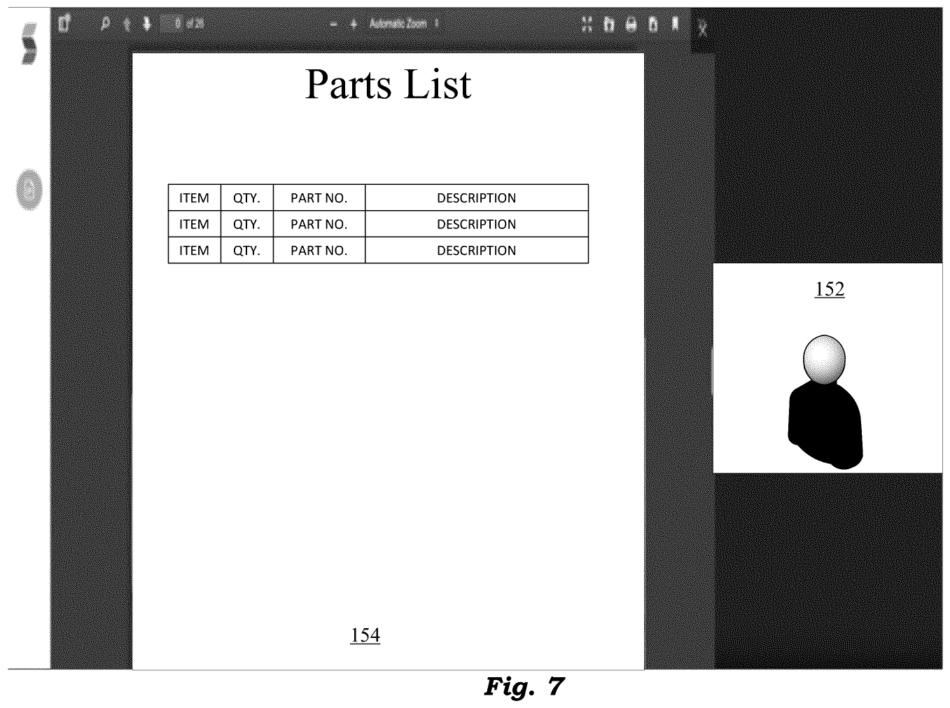

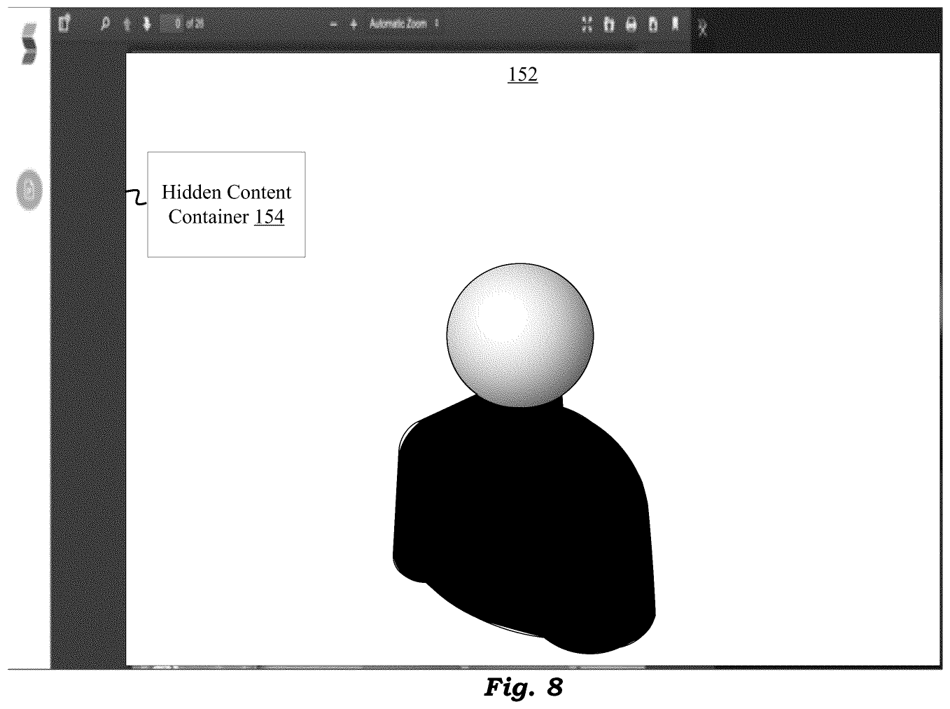

FIG. 7 shows a screenshot of an exemplary webpage of an instant online meeting showing mocked up event and content containers 154 and 152 respectively discussed in detail in reference to FIG. 2 above. Exemplarily, content container 154 shows a parts list, and event container 152 shows a host. FIG. 8 shows a variation of the screenshot of FIG. 7 where content container 154 is now hidden, and content container 154 has been automatically resized as shown.

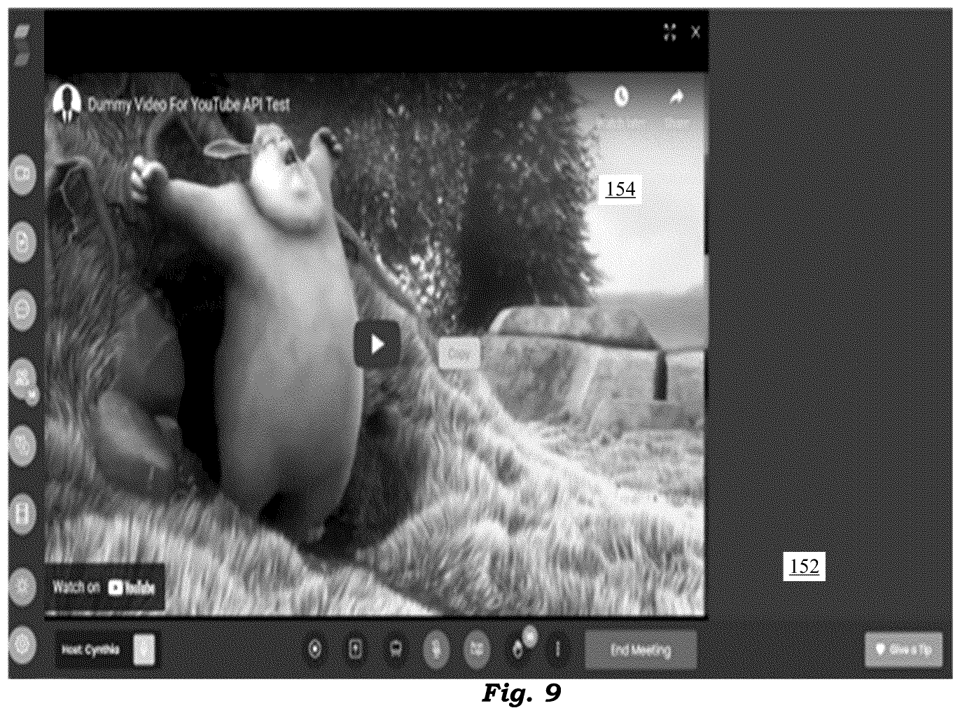

Finally, FIG. 9 shows a screenshot of an exemplary webpage of an instant online meeting showing a content container 152 with a video as the actionable/interactive client content. Also shown is event container 154 that is presently empty/blank when the screenshot of FIG. 9 was taken. Exemplarily, the host has required that the video must be watched by the participants. As such, based on the engagement level tracking capabilities of the present design taught above, the host can ensure that the video has indeed been watched.

Explained further, the above may be accomplished by utilizing a video stream from each participant to the host for a visual confirmation. Additionally, the system also tracks the time spent by each participant interacting with the content container. By combining the visual and systemic confirmations, the host can ascertain with confidence whether a participant has watched the required video or not.

Other exemplary actionable content that may be required by the host to be interacted with by the participants, includes scrolling down to a specific page of a document, filling out a form, clicking on certain web/GUI widgets, interacting with a program in a specified manner, or any other action to be performed by the participant user.

In view of the above teaching, a person skilled in the art will recognize that the apparatus and method of invention can be embodied in many different ways in addition to those described without departing from the principles of the invention. Therefore, the scope of the invention should be judged in view of the appended claims and their legal equivalents.

What is claimed is:

1. An apparatus comprising:
(a) an online meeting platform executing program instructions by at least one microprocessor, said program instructions stored in a non-transitory storage medium operably connected to said at least one microprocessor, said at least one microprocessor configured to: upload by a host, server content of an online meeting to said online meetings platform, and publish one or more webpages of said online meeting over a computer network;
(b) a participant computer system executing program instructions by at least one microprocessor, said program instructions stored in a non-transitory storage medium operably connected to said at least one microprocessor, said at least one microprocessor configured to: execute a web browser that accesses a webpage from amongst said one or more webpages via a network connection over said computer network and renders said webpage on a computer display for a participant of said online meeting;
wherein said webpage comprises an event container and a content container, and wherein said event container comprises one or both of an audio stream and a video stream of said online meeting, and wherein said content container comprises a client content of said online meeting, said client content based on said server content and existing locally on said participant computer system, and wherein said participant performs an interaction with said client content independently of said server content and without causing said webpage to reload.

2. The apparatus of claim 1, wherein said network connection stays unbroken throughout said online meeting.

3. The apparatus of claim 1, wherein said client content contains one or more of:
(c) a computer program executed on said participant computer system;
(d) a file that is one or both of viewed and edited by said participant; and
(e) a link to an external content.

4. The apparatus of claim 3, wherein said computer program is a web browser.

5. The apparatus of claim 3, wherein said file is one of a document, a multimedia file, a portable document format (PDF) file, a picture file, a software code file, an executable file, an intellectual property file, a text file and a binary file.

6. The apparatus of claim 3, wherein said link accesses one of a document, a video, a computer program, a JavaScript® application, a static content and a picture.

7. The apparatus of claim 1, tracking an engagement level of said participant with said client content.

8. The apparatus of claim 7, wherein said host is a teacher and said participant is a student.

9. The apparatus of claim 8, wherein said teacher issues a certificate of completion to said student based on said engagement level and a quiz answered by said student on said online meeting platform.

10. The apparatus of claim 1, wherein said client content is a form and wherein said interaction is a signing of that form by said participant.

11. The apparatus of claim 1, wherein said online meeting platform further comprises a payment module using which said participant makes a payment to said host.

12. The apparatus of claim 1, wherein said host is a teacher, said participant is a student, and said online meeting platform is used as a learning management system.

13. A computer-implemented method executing computer-readable instructions by at least one microprocessor, said instructions stored in a non-transitory storage medium coupled to said at least one microprocessor, and said method comprising the steps of:
(a) uploading by a host operating a host computer system, server content of an online meeting to an online meetings platform, and publishing one or more webpages of said online meeting over a computer network;
(b) executing a web browser on a participant computer system for accessing a webpage from amongst said one or more webpages via a network connection over said computer network and rendering said webpage on a computer display for a participant of said online meeting;
(c) including an event container and a content container in said webpage, and including one or both of an audio stream and a video stream of said online meeting in said event container;
(d) including client content of said online meeting in said client container, deriving said client content from said server content, and providing said client content to exist locally on said participant computer system; and
(e) performing by said participant an interaction with said client content, without reloading said webpage.

14. The computer-implement method of claim 13, keeping said network connection unbroken throughout said online meeting.

15. The computer-implement method of claim 13, including in said client content one or more of: a computer program to be executed on said participant computer system, a file that is one or both of viewed and edited by said participant, and a link to an external content.

16. The computer-implement method of claim 15, providing said file to be one of a document file, a multimedia file, a portable document format (PDF) file, a picture file, a software code file, an executable file, an intellectual property file, a text file and a binary file.

17. The computer-implement method of claim 15, providing said link to point to one of a document, a video, a computer program, a static content and a picture.

18. The computer-implement method of claim 13, providing said host to be a teacher, said participant to be a student, and said online meeting platform to be used as a learning management system.

19. The computer-implement method of claim 13, providing said client content to be a form and providing said interaction to be a signing of said form by said participant.

20. The computer-implement method of claim 13, utilizing a payment module using which said participant makes a payment to said host.
